(19) United States
(12) Patent Application Publication
(10) Pub. No.: US 2007/0029498 A1
(43) Pub. Date: Feb. 8, 2007

(54) Enhanced heteroscopic techniques

(75) Inventor: Scott Davis, Foothill Ranch, CA (US)

Correspondence Address: SWERNOFSKY LAW GROUP PC, P.O. BOX 390013, MOUNTAIN VIEW, CA, 94039-0013, US

(73) Assignee: Forced Physics LLC, a Limited Liability Company, Foothill Ranch, CA (US)

(21) Appl. No.: 11/198,926

(22) Filed: Aug. 4, 2005

(51) Int. Cl. H01J 3/14

(52) U.S. Cl. 250/396 R

(57) ABSTRACT

An enhanced heteroscopic turbine including a macroscopic rotor and an interaction, sorting, or interaction and sorting element incorporated into the rotor that operates on individual particles in a fluid. The heteroscopic turbine is enhanced by one or more of pre-processing, enhanced interaction or sorting, or post-processing. The enhancement can involve various properties of the particles, including but not limited to translational kinetic energy, non-translational kinetic energy, electromagnetic energy, electric or magnetic energy, sonic energy, chemical properties including biochemical properties and radiochemical properties, binding sites and potential, radioactive properties, enantiomer properties, ionic excitation properties, weight and properties affecting weight, atomic mass and properties affecting atomic mass, composition, photo-reactivity properties, and excitation level.

### CROSS-REFERENCE TO RELATED APPLICATIONS

This application claims priority of the following application, hereby incorporated by reference as if fully set forth herein.
United States patent application attorney docket no. 234.1015.01, titled “Coherent Emission of Spontaneous Asynchronous Radiation,” filed Aug. 4, 2005, Express Mailing number EV 568 583 396 US, in the name of inventor Scott Davis.

The following applications are each hereby incorporated by reference as if fully set forth herein.
U.S. provisional patent application No. 60/434,852, titled “Air Flow, Heat Exchange, and Molecular Selection Systems,” filed Dec. 19, 2002, in the name of inventors Scott Davis and Art Williams.
U.S. provisional patent application No. 60/499,066, titled “Molecular Speed Selection, Flow Generation, Adiabatic Cooling, and Other Heteroscopic Technologies,” filed Aug. 29, 2003, in the name of inventors Scott Davis and Art Williams.
U.S. patent application Ser. No. 10/693,635, titled “Heteroscopic Turbine,” filed Oct. 24, 2003, in the name of inventor Scott Davis, now allowed.
U.S. patent application Ser. No. 10/737,535, titled “Molecular Speed and Direction Selection,” filed Dec. 16, 2003, in the name of inventor Scott Davis, now allowed.
U.S. patent application Ser. No. 10/742,022, titled “Heat Exchange Technique,” filed Dec. 19, 2003, in the name of inventor Scott Davis.

### BACKGROUND OF THE INVENTION

1. Field of the Invention

The invention relates to heteroscopic sorting and processing of particles in fluids.

2. Related Art

Engineers and scientists generally deal with aggregate properties of fluids (i.e., gasses, liquids, plasmas, etc.) when designing and analyzing systems that involve those fluids. Particles (i.e., atoms, molecules, or even larger particles) in fluids usually are in constant motion and often have physical properties that can differ from the aggregate properties of the fluids.

For example, a fluid can be considered to be at rest when a net or average motion of particles in the fluid is zero. However, in this “at rest” fluid, particles in the fluid are still moving in many different directions and often at high speeds, namely the thermal speed for the fluid.

Likewise, particles in a fluid with a net electrical charge of zero often have positive and negative charges, sometimes even of different magnitudes. The same situation is true for magnetic charges and many other physical properties of particles in fluids.

Even in fluids that are considered to have non-zero physical properties such as net velocity or charge, many of the individual particles in that fluid have different and possibly even opposite physical properties. For example, a flow of gas that has a velocity less than a thermal velocity for molecules in that gas will include molecules that are actually moving in the opposite direction as the overall flow.

Some statistical techniques have been applied to fluids to try to analyze the effects of disparate physical properties of particles in a fluid. For example, the width of a spectral line for a gas laser is related to a range of molecular motion within the gas. This relationship has been quantified. Cooling of the gas has been attempted in order to try to minimize the magnitude of molecular motion and thereby achieve a narrower spectral line.

Similar types of problems often arise when working with other physical properties of fluids and particles in the fluids. Some attempts at imposing a macroscopic stimulus have been attempted in order to control these physical properties, for example application of a macroscopic electric or magnetic charge. While such macroscopic biases might ensure that the physical properties are all of a same direction or polarity, a disparate range of properties for the particles still usually exists within the fluid. One exception is cooling a fluid to close to absolute zero, which does result in narrowing a range of velocities of particles in the fluid. However, such cooling is often impractical for many applications.

To the inventor's knowledge, very little else has been attempted to limit the disparate physical properties of particles in a fluid that is being used in some manner.

### SUMMARY OF THE INVENTION

The invention includes methods and systems including techniques relating to heteroscopic filtering of particles, such as for example atoms or molecules of a gas. Heteroscopic filtering allows these techniques to treat each particle individually, rather than relying on aggregate properties of the gas.

As described herein, heteroscopic filtering is an enabling technology, capable of providing both new methods and new systems not heretofore feasible. Heteroscopic filtering is not restricted to kinetic aspects of sorting, nor to sorting of gas molecules in heated or cooled air. This application describes use of heteroscopic concepts in nonobvious ways and to achieve nonobvious goals.

Heteroscopic filtering sorts particles in response to their individual properties, such as for example velocity or other kinetic or physical properties. This filtering can be achieved using an annulus of sorting elements rotated at relatively high speed.

For example, the annulus might include sorting elements in the form of microscopic or nanoscopic slanted blades. This arrangement can have the effect that individual molecules of a fluid are sorted in response to the velocity at which they approach the heteroscopic filter.

The sorting elements are not required to be physical blades. A sorting element used with the invention might be one or more slanted holes in a rotating disk, a crystalline structure with a designated angular offset from a line parallel to the incoming particles, or one or more thermodynamic, electromagnetic, electric, magnetic, sonic, nuclear, or chemically active fields or regions operating to target individual particles. The sorting element might also be any other elements, substantially larger than the individual particles, but applying forces individually to each particle and not relying on aggregate properties of the gas.

Particles can have other properties to which heteroscopic filtering might be applied besides translational kinetic energy (e.g., thermal or molecular speed). These other properties can include, but are not limited to, non-translational kinetic energy (e.g., rotation, spin or spring energy), electromagnetic energy, electric or magnetic energy, sonic energy, chemical properties including biochemical properties and radiochemical properties (e.g., beta and gamma decay properties), binding sites and potential (e.g., oxidation properties, neurotoxin binding sites, isomer properties, and other properties related to chemical interaction in general or with specific substances such as hydrogen, chlorine, toxins, DNA, etc.), radioactive properties, enantiomer properties (e.g., if enantiomers exist and if they are present), ionic excitation properties, weight and properties affecting weight (e.g., fluoridation, water content, Dalton weight of molecule fragments, etc.), atomic mass and properties affecting atomic mass (i.e., presence of isotopes), composition, photo-reactivity properties, and excitation level. Properties can be deliberately induced or as found without being deliberately induced.

Embodiments of the invention disclosed herein include enhanced heteroscopic turbines and related techniques that utilizes the foregoing principles.

### BRIEF DESCRIPTION OF THE DRAWINGS

FIG. 1 shows interaction of a portion of a generalized heteroscopic turbine with a working fluid.

FIG. 2 shows a rotor for a generalized heteroscopic turbine.

FIG. 3 illustrates special regions of material or devices placed on or in a rotor for a heteroscopic turbine.

FIG. 4 illustrates special regions of materials or devices placed on or in a blade for a heteroscopic turbine.

FIG. 5 shows pre-processing, enhanced interaction and/or sorting, and post-processing for a heteroscopic turbine.

### DETAILED DESCRIPTION OF PREFERRED EMBODIMENTS

Although preferred method steps, system elements, data structures, and the like, are described herein, those skilled in the art will recognize that these are intended to describe the invention in its broadest form, and are not intended to be limiting in any way. The invention is sufficiently broad to include other and further method steps, system elements, data structures, and the like. Those skilled in the art will recognize these as workable without undue experimentation or further invention, and as within the concept, scope, and spirit of the invention.

### DEFINITIONS

The general meaning of each of these following terms is intended to be illustrative and in no way limiting.
The term “nanoscopic” and the like generally refer to particles and structures having lengths or dimensions less than or equal to a billionth of a meter.
The term “microscopic” and the like generally refer to particles and structures larger than nanoscopic particles and structures that are still very small, for example having lengths or dimensions less than or equal to one millimeter.
The term “macroscopic” and the like generally refer to particles and structures significantly larger than nanoscopic particles and structures, for example having lengths or dimensions greater than or equal to one millimeter and numbers greater than about one hundred.
The term “heteroscopic” and the like generally refer to devices characterized by use of microscopic or nanoscopic principles to select, sort, process or otherwise affect individual particles within a working fluid to achieve a macroscopic effect. More generally, heteroscopic devices are those that have structures much smaller in size than combined effects of those structures on a fluid. Heteroscopic devices might require operation on a population of objects whose size is much smaller than the desired effects.
The term “heteroscopic turbine” and the like generally refer to a plurality of single-particle systems that are incorporated as a portion of a surface of a macroscopic rotor. The single-particle system can be, for example, systems that select, sort, process or otherwise affect individual molecules or atoms within a fluid such as a gas.
The term “particle” and the like generally refer to any small component of (or suspended in) a fluid, including but not limited to molecules, atoms, sub-atomic particles, photons, charged particles, clumps of molecules, and the like.
The term “fluid” refers to any substance whose particles move past one another and that has the tendency to assume the shape of its container. Examples include, but are not limited to, a gas, liquid, plasma, electron gas, etc.
The term “forced conduction” and the like generally refer to conduction, for example of heat, that occurs with a moving surface in the absence of a physical or statistical boundary layer. Forced conduction can be achieved using a heteroscopic turbine that rotates sufficiently fast to disrupt the physical or statistical boundary layer. Individual molecules that undergo forced conduction can be aggregated at a macroscopic level to achieve highly efficient heat transfer (i.e., heating or cooling).
The terms “blade,” “blade surface” and the like generally refer to any edge that moves through a fluid. The blade can be a physical, thermodynamic, electromagnetic, sonic, chemical, nuclear, or even mathematical or statistical. Other types of blades using different forms of energy also can be used. The blade can be passive, affecting particles by their motion through the fluid, or active, directly affecting some property of the particles in some other way.
The terms “properties,” “particle properties,” “molecular properties” and the like refer to physical, statistical or mathematical properties. These properties can include, but are not limited to, translational kinetic energy (e.g., thermal or molecular speed), non-translational kinetic energy (e.g., rotation, spin or spring energy), electromagnetic energy (e.g., static, unipolar or dipole charge, dipole moment, magnetic moment, etc.), chemical properties including biochemical properties and radiochemical properties (e.g., beta and gamma decay properties), binding sites and potential (e.g., oxidation properties, neurotoxin binding sites, isomer properties, and other properties related to chemical interaction in general or with specific substances such as hydrogen, chlorine, toxins, DNA, etc.), radioactive properties, enantiomer properties (e.g., if enantiomers exist and if they are present), ionic excitation properties, weight and properties affecting weight (e.g., fluoridation, water content, Dalton weight of molecule fragments, etc.), atomic mass and properties affecting atomic mass (i.e., presence of isotopes), composition, photo-reactivity properties, and excitation level. Properties can be deliberately induced or as found without being deliberately induced.
The term “enclosure” and the like generally represent any area defined by one or more physical, mathematical, and/or statistical boundaries. Enclosures can be formed of boundaries of different types. The enclosures used by the invention are typically physically open at least on a side exposed to a working fluid. The enclosures also can be open on one or more other sides.

The scope and spirit of the invention is not limited to any of these definitions, or to specific examples mentioned therein, but is intended to include the most general concepts embodied by these and other terms.

Generalized Heteroscopic Turbine

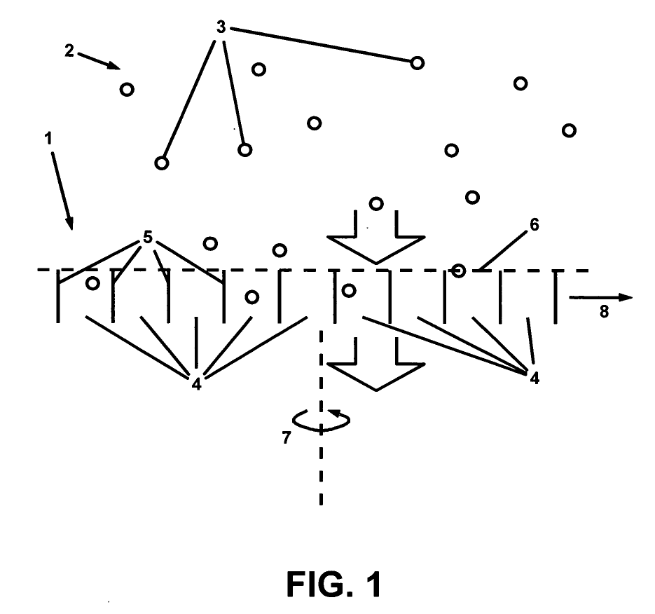

FIG. 1 shows an overall schematic of a heteroscopic turbine. This heteroscopic turbine is a generalization of the heteroscopic turbine discussed in U.S. patent application Ser. No. 10/693,635, titled “Heteroscopic Turbine.”

A heteroscopic turbine includes a plurality of single particle systems incorporated as a portion of or attached to a macroscopic rotor. Conventional means are used to achieve a rotor velocity comparable to the particles' velocity in a working fluid upon which the turbine operates. For example, in the case of a heteroscopic turbine that physically selects molecules from air, the enclosures can be formed by physical blades placed on or in the rotor, and the rotor can be spun so that the blades move through the air at a speed comparable to the mean thermal velocity of the molecules. The edges of the blades moving through the air at this velocity result in a physical boundary defining the single particle (in this case single-molecule) enclosures. This boundary also can be viewed as a mathematical or statistical boundary defined by the different properties of the particles on both sides of the boundary.

Thus, FIG. 1 shows interaction of a portion of a heteroscopic turbine 1 with a working fluid 2 composed of or including particles 3. The turbine includes a plurality of single-particle systems 4. These single-particle systems are enclosures defined by one or more physical, mathematical, and/or statistical boundaries. As shown in FIG. 1, the enclosures can each contain a particle (or possibly more than one particle in some circumstances), be empty, or be in transition. The enclosures need not be rectangular shaped as shown in FIG. 1, but rather can have any shape.

The boundaries that form the enclosure can be viewed in different ways. Generally, any physical boundary can be defined in mathematical and/or statistical terms, and vice versa. It should be noted, however, that some mathematical and/or statistical boundaries may not appear to have a physical counterpart. Alternatively, the physical counterpart might be based on a collection of physical structures and/or motion such as a plane of blade edges moving in a particular manner. The mathematical and statistical boundaries likewise might be defined, in whole or in part, in terms of space and/or time with respect to such physical structures and motion.

For example, in FIG. 1, side boundaries 5 of the enclosures can be defined by physical blades, while top boundaries 6 of the enclosures can be defined by physical motion of those blades through working fluid 2. The top boundaries can be viewed in physical terms (a plane of motion of blade tops), in mathematical terms (based on the motion of the blades or the nature of particles captured by the enclosures), or in statistical terms (based on the statistical properties of particles on both sides of the boundary). The bottoms of the enclosures can be open or can be defined by another boundary.

The blades need not be physical edges. In one embodiment, the blades can be electromagnetic blades formed, for example, by a flat surface on a rotor with regions of electromagnetically active materials or devices (i.e., magnets, electromagnets, photoactive regions such as solid-state LEDs or lasers, etc.). In these embodiments, the regions of varying electromagnetic force can form the edges. Other types of electromagnetic blades can be used. Likewise, electric, magnetic, sonic, nuclear or chemical blades are possible, as well as other variations.

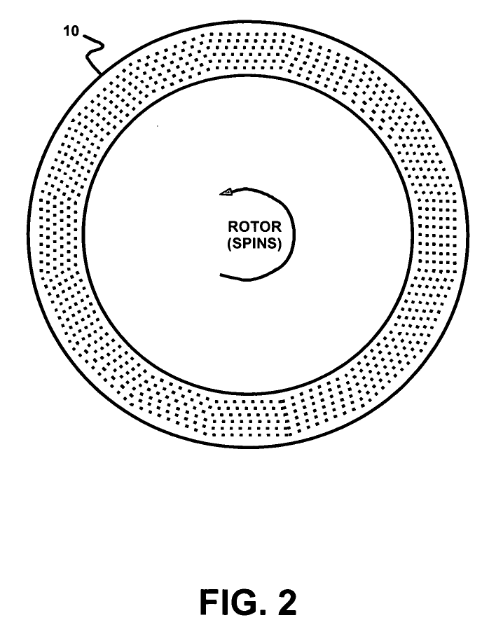

In operation, the single-particle systems are attached to a macroscopic rotor (see FIG. 2) that spins as represented by curved arrow 7. This spinning moves the systems through the working fluid as represented by arrow 8. The spinning of the rotor can affect the existence and/or characteristics of the boundaries of the enclosures.

The velocity that the rotor moves the single-particle systems through the working fluid preferably is comparable to the velocities of the particles in that working fluid. For example, if the working fluid is air, the rotor preferably spins fast enough so that the single-particle systems move through the air at a speed comparable to the mean thermal velocity of the particles in the air.

FIG. 2 illustrates macroscopic rotor 10 of a heteroscopic turbine. Rotor 10 includes single-particle systems shown as dashes around a periphery of the rotor. When the rotor spins, single-particle systems at the periphery of the rotor move faster through a working fluid than systems closer to an axis of rotation for the rotor. Thus, arrangement of the single-particle systems in the illustrated annulus shape is preferred. However, in some embodiments, the single-particle systems can be placed all over the rotor or in any other arrangement.

Depending upon the design of the single-particle systems and/or the mode of operation of the turbine, a particle might pass through an enclosure without contacting any physical surface or might collide with a physical surface in one of the systems. In any case, physical and/or logical properties can be transferred, converted, maintained and/or eliminated as permitted by the relevant thermodynamic, electrodynamic, or other physical laws.

The heteroscopic turbine can operate in several different modes. These modes include at least a non-interaction mode, an interaction mode, and a sort-and-filter mode. A heteroscopic turbine also can operate in some combination of these modes.

In non-interaction mode, particles proceed through the single-particle system enclosures via translational motion without need for, or hindrance that can result from, interaction with a physical boundary of the enclosure.

In interaction mode, particles interact in some manner with one or more physical boundaries of the single-particle system enclosures. These interactions result in a transfer, conversion, maintenance and/or elimination of one or more physical and/or logical properties of the particles.

In sort-and-filter mode, particles are separated from other particles on the basis of their specific properties.

The heteroscopic turbine can be viewed as a system having three parts: an input flow, an interaction and/or sorting element, and an output flow. These are shown in FIG. 1.

Input flow 12 is the flow of particles into or in the vicinity of the heteroscopic turbine. The flow can be comprised of molecules, radicals (molecular entities with unpaired electrons (lacking a proton), and/or other types of particles such as neutral or ionic atoms, neutral or charged subatomic particles, and neutral or charged molecular clumps such as crystals or precipitates. The flow (and composing particles) can be any temperature. Typically, the particles in the flow exhibit Brownian motion, although this need not be the case.

The interaction and/or sorting element 14 includes a plurality of blades that are moved through the input flow at high speeds, preferably on the order of the mean velocity of the particles in the input flow. If the input flow is comprised of a gas or liquid, this velocity is preferably the mean thermal velocity of the molecules (or other particles of interest) in the gas or liquid. Alternatively, the blades can be moved faster (or even slower, as long as heteroscopic effects occur) through the input flow.

The blades of the interaction and/or sorting element can be, for example, physical, thermodynamic, electromagnetic, electric, magnetic, sonic, chemical, nuclear, or even mathematical or statistical. As with the boundaries of the enclosures discussed above, the blades can often be viewed in both physical and mathematical or statistical terms. The blade can be passive, affecting particles by their motion through the fluid of the input flow, or active, directly affecting some property of the particles in some other way. Motion of the blades defines the boundaries that form the single-particle systems discussed above. In statistical terms, the boundaries defined by the blades can have a one-sided or multi-sided statistical distribution.

The output flow 15 is comprised of particles that have been sorted or otherwise affected by the interaction/sorting element. For example, in a speed-selecting implementation of the heteroscopic turbine, the output flow is comprised of particles moving sufficiently fast and in the right direction to pass through the single-particle systems defined by motion of the blades of the interaction/sorting element.

In another embodiment, the output flow can be collimated. In the case that the particles are molecules of a fluid, the output flow might then comprise a thin (fluid) film that is a planar collimated molecular beam. Other types of output flows can be generated.

In most embodiments, the input flow and output flow should have different statistical distributions of some type of energy or other characteristic. The characteristics of the output flow are defined by the input flow and the design of the interaction/sorting element. Some examples of different combinations and designs of these elements are given below.

Enhanced Heteroscopic Turbine

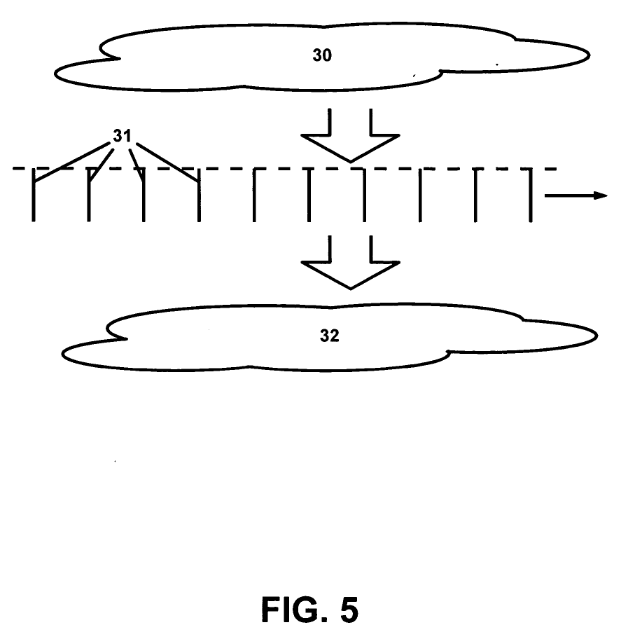

The basic kinetic-based heteroscopic turbine can be enhanced in many ways to achieve a diversity of different and non-obvious results. These modifications include changes to the nature of the blades and other design modifications to affect properties other than kinetic properties of particles. In addition, pre-processing and post-processing can be used to further enhance operation of the heteroscopic turbine. This is illustrated in FIG. 5, which shows pre-processing 30, enhanced interaction and/or sorting 31, and post-processing 32.

Enhanced Interaction/Sorting

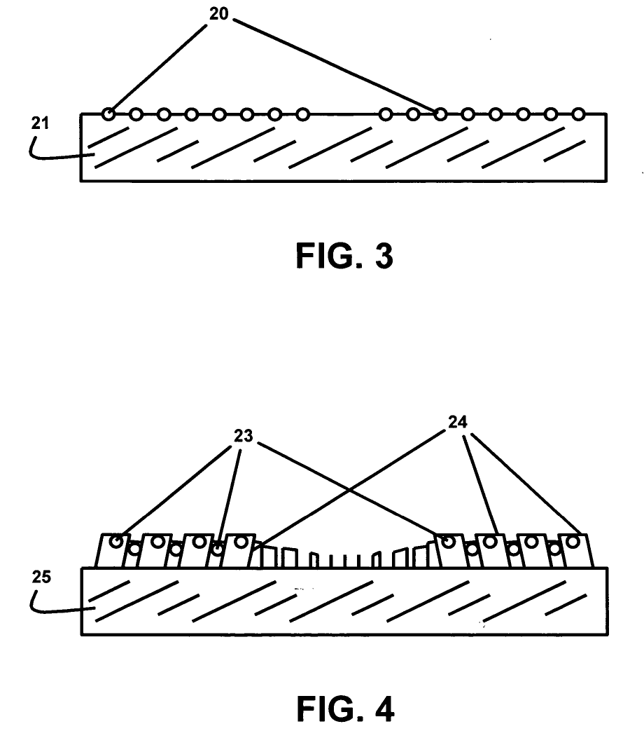

In many embodiments of enhanced heteroscopic turbines, special regions of material or devices are placed on or in the rotor for the heteroscopic turbine, in place of physical blades. These materials or devices can have, for example, electromagnetic, electric, magnetic, sonic, nuclear, energy emitting, or other properties. This is illustrated in FIG. 3, which shows materials or devices 20 placed on or in rotor 21 (shown in cross section at the diameter). In this Figure, the materials or devices are represented by circles. However, there is no requirement that the materials or devices be round or have any other particular shape. Furthermore, the materials or devices are not necessarily shown to scale—in most embodiments, they should be much smaller and placed with much higher density.

Alternatively, such materials or devices can be placed on or in physical blades that are placed on or in the rotor. This is illustrated in FIG. 4, which shows materials or devices 23 placed on or in physical blades 24, which in turn are placed on or in rotor 25 (shown in cross section at the diameter). In this Figure, only some materials or devices 23 are shown for the sake of simplicity and viewability. Again, the materials or devices are represented by circles. However, there is no requirement that the materials or devices be round or have any other particular shape. Furthermore, the materials or devices are not necessarily shown to scale—in most embodiments, they should be much smaller and placed with much higher density.

In yet other embodiments, the physical blades themselves can be made of the special materials or devices. Other variations exist and are within the scope of the invention.

Many examples of different ways to enhance the blades and interaction and/or sorting elements are discussed in more detail below.

Passive versus Active Blades

The blades of the interaction/sorting element can be “passive” or “active.” Passive blades affect particles by their motion through the fluid, for example by only allowing certain types of particles to pass through while rejecting other types of particles. Active blades directly affect some property of the particles in some other way. For example, if the blades are heated, they can impart additional kinetic energy to the particles. If the blades are charged, they can impart a charge to the particles. Other variations exist.

In some embodiments, the blades can have both passive and active characteristics. For example, charged blades can attract and then allow oppositely-charged particles through, possibly neutralizing some or all of the charge on the particles, while repelling like-charged particles. Other variations exist.

Energy Emitting Blades

A sub-set of active blades are those that emit some form of energy. Examples of the type of energy that can be emitted include thermodynamic energy (i.e., heat), electromagnetic energy, electric energy, magnetic energy, sonic energy, nuclear energy, chemical energy, and other types of energy.

Thermodynamic Activity

A heteroscopic turbine's physical blades can be viewed in thermodynamic terms, more specifically in terms of their interaction with particles based on the particles translational kinetic energy.

In addition, some embodiments of heteroscopic turbines can interact with particles based on non-translational kinetic energy. For example, blades can be angled or roughened to select for particular particle rotation.

Electromagnetic Activity

As discussed above, electromagnetically active blades can be formed from, for example, electromagnetically active regions of material or devices (i.e., magnets, electromagnets, photoactive regions such as solid-state LEDs or lasers, etc.) placed on or in the rotor for the heteroscopic turbine. Alternatively, such material or devices can be placed on or in physical blades that are placed on or in the rotor. In these embodiments, the regions of varying electromagnetic force can form or augment the edges that define the boundaries for the single particle systems of the turbine.

The electromagnetically active material or devices can carry or generate, for example, a static charge, non-static charge, dipole moment, or magnetic moment. Alternatively, the blades can affect the electromagnetic properties of particles that strike it, for example by absorbing, diffracting, or polarizing photons.

In other embodiments, the electromagnetically active regions can emit photons. For example, the blades can include elements such as solid-state laser diodes or other devices that generate electromagnetic fields. These photons can then excite nearby particles or a subset of nearby particles.

For example, for particles such as molecules or crystals that can be characterized by their lattice vibrations, photons absorbed by those particles can alter those lattice vibrations. This alteration can change the way in which the particles interact with the blades.

In some of these embodiments, absorbed photons result in an increase in lattice vibrations, which in turn can result in more energetic collisions with physical blades (if present) or more energetic passage or rejection by the interaction/sorting elements.

In others of these embodiments, a specific frequency or range of frequencies of photons can be used to selectively affect certain particles. This again can have the affect of increasing the lattice vibrations of those particles, thereby providing another means for selectively affecting a subset of particles. Faster or slower moving particles can be speed selected or otherwise processed by the heteroscopic turbine.

The resulting change or selection of faster or slower particles can further be used in subsequent or concurrent chemical processes. For example, faster particles can be selected from one region by the heteroscopic turbine for introduction as in the output flow into a space where a desired chemical process is to take place. By only introducing the more energetic particles into that space, more controlled and/or faster chemical reactions can be encouraged.

In other embodiments, the electromagnetic activity can be generated by the output flow from the heteroscopic turbine. For example, light passing through a particle beam comprising the output flow can exhibit optical activity such as rotating a plane of polarization of light passing through the flow. A heteroscopic turbine designed to generate a planar collimated molecular beam is particularly suited to this application.

Electric and Magnetic Activity

Electrically active blades can be formed from, for example, regions of charge generating, absorbing or otherwise affecting material or devices placed on or in the physical blades or rotor. In these embodiments, the regions of varying electric activity (i.e., charge state) can form or augment the edges that define the boundaries for the single particle systems of the turbine. Magnetically active blades can be implemented in a similar fashion.

Sonic Activity

Sonically active blades can be formed from, for example, regions of sound generating, absorbing or otherwise affecting material or devices placed on or in the physical blades or rotor. In these embodiments, the regions of varying sonic activity (i.e., sound waves) can form or augment the edges that define the boundaries for the single particle systems of the turbine.

Nuclear Activity

Nuclear active blades can be formed from, for example, material or devices that generate, absorb, or otherwise affect nuclear charges and forces. For example, the regions can be radioactive, thereby stimulating, attracting, or repelling particles based on their nuclear properties. Again, the regions of varying nuclear activity can form or augment the edges that define the boundaries for the single particle systems of the turbine.

Chemical Activity

Chemically active blades can be formed from, for example, regions of chemically active materials or devices placed on or in the physical blades or rotor. In these embodiments, the regions of varying chemical activity can form or augment the edges that define the boundaries for the single particle systems of the turbine.

Many types of chemically active material or devices can be used in these embodiments. For example, the material or devices can exhibit biochemical or radiochemical activity.

Biochemical blades can be used to select for, and therefore detect (by monitoring the output flow), specific types of biochemicals. The chemically active material or devices can be designed to interact with particular binding sites and potentials. Thus, the material or devices can be designed to interact with particular oxidation properties, neurotoxin binding sites, isomer properties, and other properties related to chemical interaction in general or with specific substances such as hydrogen, chlorine, radon, toxins, DNA, etc. Thus, the material or devices can be designed to interact with only a particular chemical or class of chemicals.

Particles exhibiting the properties corresponding to the chemical activity of the blades can be selected or otherwise specifically affected by heteroscopic turbines that use chemically active blades. In some embodiments, the particles are selected based on their chemical activity so that only (or possibly just more of) those types of chemicals appear in the output flow, thereby aiding detection of those particles in the output flow. Alternatively, the blades can be designed to absorb those chemicals, allowing for removal of the chemicals from the input flow. Other variations are possible.

Likewise, radiochemical blades can be used to select for, and therefore select or otherwise affect, specific types of radiochemical decay such as beta and gamma decay.

A subset of chemical activity is ionic activity (e.g, ionic excitation levels). Thus, material or devices on the blades can be designed to interact preferentially with certain ions of chemicals.

Piezoelectric Activity

Piezoelectric materials or devices can be used with the blades, for example on a surface of the blades. Particle-surface collisions result in a transfer of momentum from the particles to the piezoelectric element. The piezoelectric element can generate a charge from this transfer of momentum. The charge is proportional to the particle's momentum, thereby providing a measure of the charge's (angular) momentum.

If the particle's velocity (e.g., temperature) is known, the particle's mass can be determined. Thus, the measure of momentum can provide a way to determine the particle's species in real time.

Mass and Weight Considerations

Masses and weights of particles also can vary depending on molecular variants (e.g., fluoridated or not), absorbed water content, Dalton weight of molecular fragments (related to petroleum cracking), atomic mass differences (e.g., radioisotopes), and the like. Embodiments of the heteroscopic turbine that can sort based on mass and/or weight can be used to sort and filter based on these considerations.

Fluid State Considerations

Many particles, especially molecules and atoms in gasses, liquids, plasmas, and fluidized solids, exhibit Brownian motion. Heteroscopic turbines can be used to filter and sort these particles based on their fluid velocity distribution.

Coated Blades

The physical blades can be coated with various materials. In some embodiments, the coating alters the flow or nature of particles than interact with the coating. For example, the coating can be a catalyst that promotes reactions in the input flow.

In other embodiments, the coating can be an active component that directly reacts with particles in the input flow. This reaction can be a chemical reaction, kinetic reaction (e.g., altering a speed of particles, for example by being “sticky” or “springy”), or any other type of reaction.

In yet other embodiments, the coating can be a substance that detects certain types of particles. For example, the coating could be sensitive to radioactive molecules or specific inimical chemicals such as chlorine, neurotoxins, and the like. The heteroscopic nature of the heteroscopic turbine can ensure that many particles are exposed to this coating, thereby providing for improved exposure and detection. As another example, the coating can be a photosensitive or photoreactive to achieve light-dependent results.

Circuitry on Blades

Circuitry can be placed on or in the physical blade or rotor. This circuitry can be used, for example, for statistical triggering (e.g., photomultipliers) or statistical electrical effects (e.g., FET switches). In addition, circuitry can be used to link different material or devices used in combination to enhance a heteroscopic turbine. Such circuitry can even be used to link such material or devices to devices that are external to the actual heteroscopic turbine.

Multiple Sets of Blades

An enhanced heteroscopic turbine according to the invention can have multiple sets of blades. These blades can be of different sizes or even of different types, possibly both physical and non-physical. The blades can even have sub-blades, for example controlled by circuitry on the blades to provide for vernier adjustments to fine-tune characteristics of the blades. Different sets of blades also can be used to select for different beat frequencies.

In an elaboration on these embodiments, different sets of blades can be placed on different co-axial rotors that move in opposite directions.

High Velocity Operation

The blades of the interaction/sorting element that define the single-particle systems can move faster than the mean velocity of the particles in the input flow. This is referred to as “high velocity operation” herein. High velocity operation can be used with any types of blades.

In the case of solid (physical) material blades, high velocity operation can be used to implement heteroscopic turbines that select, filter, or otherwise operate upon high speed particles. The velocity of the blades displace “gaps” between particles, for example fast-moving molecules, elementary particles such as hot neutrons (for nuclear applications), and the like. This operation can be used to select, reject, or otherwise affect a particular subset of particles in the input flow.

Sufficiently fast blades also can be used for photon filtering, possibly with optically active blades that emit or absorb photons. Such embodiments can be used, for example, as optical filters, absorption filters, and wavelength or frequency filters.

The extreme end of high velocity operation encompasses blades that “move” at faster-than-light (FTL) speed. This is not a violation of relativity for non-physical blades because the speed at which an image moves (that is, energy enters and leaves a spatial region) can be faster than the speed of light without any transfer of information or mass-energy at greater than the speed of light. (The speed an image can move is sometimes called the “speed of dark”; this speed is potentially infinite).

FTL blades can provide a very narrow selection criteria, resulting in a very narrow statistical distribution in the output flow. FTL blades also are suited for embodiments that operate on input flows with very fast particles such as hot neutrons or on very dense input flows (e.g., near-liquid conditions).

Sensors

The blades of some embodiments of the heteroscopic turbine can be designed to include sensors that detect any of various forms of energy. These sensors can then be connected to devices that introduce or utilize any of the forms of activity discussed above, possibly through circuitry included on or in the physical blades or rotor.

For another example, sensors can be used to help select or affect enantiomers (e.g., chiral molecules) differently depending on their “handedness.” Differently handed enantiomers exhibit different optical activity. The blades can emit photons (i.e., electromagnetic energy) that affect the differently handed molecules differently. Sensors on the blades can detect this optical activity. These sensors can be connected to electromagnetically active material or devices on the blades or possibly to macroscopic devices directed toward the blades. Then, when optical activity corresponding to a particular handedness of molecules is detect, the electromagnetically active material or devices can excite the molecules exhibiting that optical energy, increasing their thermal speed. Physical (or other types) of blades on the heteroscopic turbine can be designed to speed sort the input flow containing the molecules, resulting in selection of these excited molecules.

Pre-Processing

As mentioned above, embodiments of the heteroscopic turbine can be enhanced by pre-processing the input flow.

One example of pre-processing is to pass the input flow through a centrifuge to increase a variance of distribution of motion within the input flow. Alternatively, a cooling laser can be used to remove portions of the distribution.

Electromagnetic fields can be used to twist a path of particles in the input flow. Electrostatic fields can be used to introduce a transverse velocity component. Like-wise, the energy state of particles in the input flow could be raised by subjecting the input flow to some form of energy, for example from an x-ray source or pumping laser. These and other types of fields can be used to affect the characteristics of the input flow.

Any other type of pre-processing can be used to impart desired characteristics to the input flow and/or to particles within the input flow.

Post-Processing

Also as mentioned above, embodiments of the heteroscopic turbine can be enhanced by post-processing the output flow.

For example, a heteroscopic turbine can be used to select particles having a narrow range of kinetic or other properties. Because such particles would not exhibit significant Brownian motion, they can be used to generate narrow frequency effects. A variation on this effect is used by the laser described in the incorporated application titled “Laser.”

As another example, once a particular speed (i.e., temperature) of particles has been selected by a heteroscopic turbine for an output flow, those particles could be further cooled by a cooling laser tuned to those particles' speed. This permits much more efficient cooling.

Other embodiments could post-process the selected particles with one or more subsequent heteroscopic turbines.

Combinations

Each of the different types of blade activity and variations discussed above can be combined with some or all of the others.

For example, blades can be both electromagnetically and chemically active. The blades can emit photons (i.e., electromagnetic energy) to excite certain particles in the input flow. The blades can also be chemically active so as to selectively interact with ions. Thus, in some embodiments, only (or primarily) ionized versions of a particular chemical can appear in the output flow. Other types of energy also can be used to excite or otherwise affect the particles for selection or processing based upon an altered state.

For another example, blades can be both piezoelectrically active and energy emitting. Particles with different angular momentums, masses or weights can generate different currents based on these properties when they strike the piezoelectric elements. Simple circuitry can be used to activate energy emitting elements when the generated currents are within a particular range. This energy, which can take any of the forms discussed herein, can excite those particles. The excited particles can be speed sorted, thereby providing a way to sort and filter particles based on their momentums, masses or weights.

### Alternative Embodiments

Although preferred embodiments are disclosed herein, many variations are possible which remain within the concept, scope, and spirit of the invention. These variations can become clear to those skilled in the art after perusal of this application.

1. An enhanced heteroscopic turbine, comprising:
a macroscopic rotor; and
a heteroscopic interaction, sorting, or interaction and sorting element incorporated into the rotor that operates on individual particles in a fluid;
wherein the heteroscopic turbine is enhanced by one or more of pre-processing, enhanced interaction or sorting, or post-processing.

2. An enhanced heteroscopic turbine as in claim 1, wherein the particles comprise atoms that are components of a gas or liquid, atoms suspended in a gas or liquid, molecules that are components of a gas or liquid, molecules suspended in a gas or liquid, clumps of molecules that are components of a gas or liquid, clumps of molecules suspended in a gas or liquid, sub-atomic particles, photons, and/or charged particles.

3. An enhanced heteroscopic turbine as in claim 1, wherein the interaction, sorting, or interaction and sorting element includes special regions of material or devices placed on or in the rotor for the heteroscopic turbine, placed on or in physical blades that are placed on or in the rotor, or comprise the physical blades.

4. An enhanced heteroscopic turbine as in claim 3, wherein the special regions of material or devices have electromagnetic, electric, magnetic, sonic, nuclear, or energy emitting properties.

5. An enhanced heteroscopic turbine as in claim 1, wherein the interaction, sorting, or interaction and sorting element includes passive blades placed on or in the rotor.

6. An enhanced heteroscopic turbine as in claim 1, wherein the interaction, sorting, or interaction and sorting element includes active blades placed on or in the rotor.

7. An enhanced heteroscopic turbine as in claim 1, wherein the interaction, sorting, or interaction and sorting element includes energy emitting blades.

8. An enhanced heteroscopic turbine as in claim 1, wherein the interaction, sorting, or interaction and sorting element includes thermodynamically active blades.

9. An enhanced heteroscopic turbine as in claim 8, wherein the thermodynamically active blades interact with the particles based on their translational kinetic energy.

10. An enhanced heteroscopic turbine as in claim 8, wherein the thermodynamically active blades interact with the particles based on their non-translational kinetic energy.

11. An enhanced heteroscopic turbine as in claim 1, wherein the interaction, sorting, or interaction and sorting element includes electromagnetically active blades.

12. An enhanced heteroscopic turbine as in claim 11, wherein the electromagnetically active blades include regions of electromagnetically active material or devices placed on or in the rotor for the heteroscopic turbine or placed on or in physical blades that are placed on or in the rotor.

13. An enhanced heteroscopic turbine as in claim 12, wherein the electromagnetically active material or devices carry or generate a static charge, non-static charge, dipole moment, or magnetic moment.

14. An enhanced heteroscopic turbine as in claim 11, wherein the electromagnetically active blades affect electromagnetic properties of the particles that strike the blades by emitting, absorbing, diffracting, or polarizing photons.

15. An enhanced heteroscopic turbine as in claim 14, wherein the electromagnetically active blades emit photons and the photons are absorbed by the particles, resulting in more energetic collisions with the blades.

16. An enhanced heteroscopic turbine as in claim 14, wherein the photons are of a specific frequency or range of frequencies so as to selectively affect certain of the particles.

17. An enhanced heteroscopic turbine as in claim 1, wherein the interaction, sorting, or interaction and sorting element includes electrically active blades.

18. An enhanced heteroscopic turbine as in claim 17, wherein the electrically active blades include regions of electrically active material or devices placed on or in the rotor for the heteroscopic turbine or placed on or in physical blades that are placed on or in the rotor.

19. An enhanced heteroscopic turbine as in claim 1, wherein the interaction, sorting, or interaction and sorting element includes magnetically active blades.

20. An enhanced heteroscopic turbine as in claim 19, wherein the magnetically active blades include regions of magnetically active material or devices placed on or in the rotor for the heteroscopic turbine or placed on or in physical blades that are placed on or in the rotor.

21. An enhanced heteroscopic turbine as in claim 1, wherein the interaction, sorting, or interaction and sorting element includes sonically active blades.

22. An enhanced heteroscopic turbine as in claim 21, wherein the sonically active blades include regions of sonically active material or devices placed on or in the rotor for the heteroscopic turbine or placed on or in physical blades that are placed on or in the rotor.

23. An enhanced heteroscopic turbine as in claim 1, wherein the interaction, sorting, or interaction and sorting element includes blades that exhibit nuclear activity.

24. An enhanced heteroscopic turbine as in claim 23, wherein the blades that exhibit nuclear activity include regions of material or devices that exhibit nuclear activity placed on or in the rotor for the heteroscopic turbine or placed on or in physical blades that are placed on or in the rotor.

25. An enhanced heteroscopic turbine as in claim 24, wherein the material or devices are radioactive, thereby stimulating, attracting, or repelling particles based on their nuclear properties.

26. An enhanced heteroscopic turbine as in claim 1, wherein the interaction, sorting, or interaction and sorting element includes chemically active blades.

27. An enhanced heteroscopic turbine as in claim 26, wherein the chemically active blades include regions of chemically active material or devices placed on or in the rotor for the heteroscopic turbine or placed on or in physical blades that are placed on or in the rotor.

28. An enhanced heteroscopic turbine as in claim 27, wherein the chemically active material or devices exhibit biochemical activity.

29. An enhanced heteroscopic turbine as in claim 28, wherein the chemically active material or devices interact with particular oxidation properties, neurotoxin binding sites, isomer properties, and other properties related to chemical interaction in general or with specific substances such as hydrogen, chlorine, radon, toxins, and DNA.

30. An enhanced heteroscopic turbine as in claim 27, wherein the chemically active material or devices exhibit radiochemical activity.

31. An enhanced heteroscopic turbine as in claim 30, wherein the chemically active material or devices interact with specific types of radiochemical decay such as beta and gamma decay.

32. An enhanced heteroscopic turbine as in claim 1, wherein the interaction, sorting, or interaction and sorting element includes piezoelectrically active blades.

33. An enhanced heteroscopic turbine as in claim 1, wherein the interaction, sorting, or interaction and sorting element filters and sorts the particles based on their fluid velocity distribution.

34. An enhanced heteroscopic turbine as in claim 1, wherein the interaction, sorting, or interaction and sorting element includes coated blades.

35. An enhanced heteroscopic turbine as in claim 34, wherein the blades are coated with a coating that alters a flow or nature of the particles.

36. An enhanced heteroscopic turbine as in claim 34, wherein the blades are coated with a coating that reacts with the particles in the fluid.

37. An enhanced heteroscopic turbine as in claim 34, wherein the blades are coated with a coating that detects certain types of particles.

38. An enhanced heteroscopic turbine as in claim 1, wherein the interaction, sorting, or interaction and sorting element includes circuitry.

39. An enhanced heteroscopic turbine as in claim 38, wherein the circuitry is on or in the rotor for the heteroscopic turbine.

40. An enhanced heteroscopic turbine as in claim 38, wherein the interaction, sorting, or interaction and sorting element includes physical blades, and wherein the circuitry is on or in the blades.

41. An enhanced heteroscopic turbine as in claim 38, wherein the circuitry links different materials or devices used to enhance the heteroscopic turbine with each other.

42. An enhanced heteroscopic turbine as in claim 38, wherein the circuitry links material or devices used to enhance the heteroscopic turbine to devices that are external to the heteroscopic turbine.

43. An enhanced heteroscopic turbine as in claim 1, wherein the interaction, sorting, or interaction and sorting element includes multiple sets of blades.

44. An enhanced heteroscopic turbine as in claim 1, wherein the interaction, sorting, or interaction and sorting element moves faster than the mean velocity of the particles.

45. An enhanced heteroscopic turbine as in claim 44, wherein the blades have faster-than-light aspects.

46. An enhanced heteroscopic turbine as in claim 1, wherein the interaction, sorting, or interaction and sorting element includes sensors.

47. A method of processing a fluid, comprising the steps of:
disposing a heteroscopic turbine in a path of a fluid, the heteroscopic turbine including a macroscopic rotor and a heteroscopic interaction, sorting, or interaction and sorting element; and
moving said rotor so that said interaction, sorting, or interaction and sorting element operates on individual particles in said fluid;
wherein the heteroscopic turbine is enhanced by one or more of pre-processing, enhanced interaction or sorting, or post-processing.

48. A method as in claim 47, wherein the particles comprise atoms that are components of a gas or liquid, atoms suspended in a gas or liquid, molecules that are components of a gas or liquid, molecules suspended in a gas or liquid, clumps of molecules that are components of a gas or liquid, clumps of molecules suspended in a gas or liquid, sub-atomic particles, photons, and/or charged particles.

49. A method as in claim 47, wherein the interaction, sorting, or interaction and sorting element includes special regions of material or devices placed on or in the rotor for the heteroscopic turbine, placed on or in physical blades that are placed on or in the rotor, or comprise the physical blades.

50. A method as in claim 49, wherein the special regions of material or devices have electromagnetic, electric, magnetic, sonic, nuclear, or energy emitting properties.

51. A method as in claim 47, wherein the interaction, sorting, or interaction and sorting element includes passive blades placed on or in the rotor.

52. A method as in claim 47, wherein the interaction, sorting, or interaction and sorting element includes active blades placed on or in the rotor.

53. A method as in claim 47, wherein the interaction, sorting, or interaction and sorting element includes energy emitting blades.
